(19) United States
(12) Patent Application Publication
(10) Pub. No.: US 2026/0221651 A1
(43) Pub. Date: Jul. 30, 2026

(54) ANTENNA ALIGNMENT USING STATE ESTIMATION FILTERS

(71) Applicant: BAE Systems Space & Mission Systems Inc., Broomfield, CO (US)

(72) Inventors: Lydia Renee Salazar Dahl, Lafayette, CO (US); Joshuah James McCrory, Firestone, CO (US); William Robert Trochman, Longmont, CO (US); Benjamin Ian Caron, Westminster, CO (US); Joshua Taylor Lane, Aurora, CO (US); Spencer Reed Arrasmith, Superior, CO (US); Mason S. Stone, Louisville, CO (US); Anthony Romero Carrillo, Westminster, CO (US)

(73) Assignee: BAE Systems Space & Mission Systems Inc., Broomfield, CO (US)

(21) Appl. No.: 19/456,957

(22) Filed: Jan. 22, 2026

Related U.S. Application Data
(60) Provisional application No. 63/749,867, filed on Jan. 27, 2025.

(51) Int. Cl. H01Q 3/36; H04B 17/21

(52) U.S. Cl. CPC H01Q 3/36; H04B 17/221

(57) ABSTRACT

Systems and methods are described for orientating an antenna with respect to a reference device. Systems include circuits configured to: predict a state of alignment angles of the antenna as compared to the reference device, use the state to steer the antenna toward a first data source, receive data from the first data source, based on the data from the first data source, determine an error in the state, update the state based on the determined error, and orientate the antenna based on the updated state.

### CROSS-REFERENCE TO RELATED APPLICATION

The present application claims the benefit of and priority, under 35 U.S.C. § 119(e), to U.S. Provisional Patent Application No. 63/749,867, filed Jan. 27, 2025, and entitled “ORIENTATION FOR PHASED ARRAY ANTENNA SYSTEMS” the entire disclosure of which is hereby incorporated herein by reference, in its entirety, for all that it teaches and for all purposes.

### FIELD OF THE DISCLOSURE

The present disclosure is generally directed toward communication antennae and, in particular, toward enabling an antenna system to determine an orientation.

### BACKGROUND

Radio frequency (RF) communication links are commonly used to transfer information and to control devices. RF signals are also used by radar devices for remote sensing operations. In order to send and receive RF signals, various antenna types, including phased array antennae, have been developed. In a typical phased array antenna, radiating elements are arranged in a two-dimensional array. Phased array antenna systems have a variety of applications in present day communications and surveillance systems. For example, phased array antenna systems can be used in high performance wireless communications networks, such as Multi Input Multi Output (MIMO) antenna arrays associated with fifth generation 5G cellular communications systems. In such applications, the beam pattern produced by the antenna is often dynamically steered or modulated by selectively controlling the phase and amplitude of signals associated with different antenna elements. By controlling the phase of the signal at selected elements in the array, the resulting beam can be pointed or steered. This in turn can facilitate the gain realized by the antenna relative to a far field transceiver, endpoint, or target.

### BRIEF SUMMARY

Embodiments of the present disclosure are directed to systems and methods for orientating an antenna with respect to a reference device. More particularly, the systems and methods presented herein enable an algorithm to determine a difference in orientation between an antenna such as an electronically steered array (ESA) and a reference device such as an inertial rate unit (IRU) in terms misalignment angles in three orthogonal axes. The difference in orientation between the antenna and reference device may be used to orient the antenna to provide transmission services using the antenna.

Systems in accordance with embodiments of the present disclosure include a control circuit for orientating an antenna with respect to a reference device, the control circuit configured to: predict a state of the antenna as compared to the reference device; use the state to steer the antenna toward a first data source; receive data from the first data source; based on the data from the first data source, determine an error in the state; update the state based on the determined error; and orientate the antenna based on the updated state.

Systems in accordance with embodiments of the present disclosure also include an apparatus comprising one or more circuits to: predict a state of an antenna as compared to a reference device; use the state to steer the antenna toward a first data source; receive data from the first data source; based on the data from the first data source, determine an error in the state; update the state based on the determined error; and orientate the antenna based on the updated state.

Methods in accordance with embodiments of the present disclosure include a method for orientating an antenna with respect to a reference device, the method comprising: predicting a state of the antenna as compared to the reference device; using the state to steer the antenna toward a first data source; receiving data from the first data source; based on the data from the first data source, determining an error in the state; updating the state based on the determined error; and orientating the antenna based on the updated state.

Aspects of the above systems and methods include using the updated state to steer the antenna toward a second data source; receiving data from the second data source; and based on the data from the second data source, updating the error in the state.

Aspects of the above systems and methods include repeating predicting the state, steering the antenna, determining the error, updating the state, and orientating the antenna based on the updated state for a preconfigured amount of time.

Aspects of the above systems and methods include wherein determining the error in the state comprises calculating a measurement residual based on the data.

Aspects of the above systems and methods include wherein the error in the state is determined using a state estimation algorithm such as an Unscented Kalman Filter (UKF).

Aspects of the above systems and methods include wherein the first data source is an RF transmission source with a known frequency and location. In some implementations, the first data source may be an RF emitter with a known frequency and relative position. A known relative position may be in terms of latitude, longitude, and altitude, or an angular vector definition relative to a local location such as azimuth and elevation (Az/El) pointing (e.g., unit) vector from a steering origin of the antenna.

Aspects of the above systems and methods include wherein the antenna is steered toward the first data source using open loop steering.

Aspects of the above systems and methods include wherein the data is one or more of a received signal strength indicator (RSSI), a signal to noise ratio (SNR), a signal-to-interference-plus-noise ratio (SINR), an energy per symbol to noise power spectral density ratio (E_{S}/N₀), an energy per bit to noise power spectral density ratio (E_{b}/N₀), or any other type of feedback.

Aspects of the above systems and methods include determining the error is less than a threshold.

Aspects of the above systems and methods include, in response to determining the error is less than the threshold, using the updated state to steer the antenna to provide a communication service.

Aspects of the above systems and methods include determining the error is greater than a threshold.

Aspects of the above systems and methods include, in response to determining the error is greater than a threshold, using the updated state to steer the antenna to a second data source and repeating predicting the state, steering the antenna, determining the error, updating the state, and orientating the antenna based on the updated state for a preconfigured amount of time.

Aspects of the above systems and methods include wherein the reference device comprises one or more of an inertial rate unit, an inertial measurement unit, a gyroscopic sensor, and an inertial navigation system.

Aspects of the above systems and methods include wherein the antenna comprises an assembly electronically steered array (ESA), a phased array, a parabolic antenna, or a dish antenna.

Aspects of the above systems and methods include wherein the data may comprise a continuous wave signal, and/or a modulated data signal, broadcast from an rf emission source with a known frequency and location, and wherein the control circuit is further configured to perform digital signal processing of a continuous wave signal, or modulated data signal, to determine the error in the state.

Aspects of the above systems and methods include wherein the state comprises of three misalignment angles about three orthogonal axes.

Aspects of the above systems and methods include wherein the error in the state is determined based at least in part on a truth source comprising a vector, derived from an RF feedback source with a known location, defined in spherical, cartesian, or UV coordinate frames.

Additional features and advantages of embodiments of the disclosed systems and methods will become more readily apparent from the following description, particularly when taken together with the accompanying drawings.

### BRIEF DESCRIPTION OF THE SEVERAL VIEWS OF THE DRAWINGS

The present disclosure is described in conjunction with the appended figures, which are not necessarily drawn to scale:

FIG. 1 depicts an exemplary operating environment in accordance with embodiments of the present disclosure;

FIG. 2 depicts an exemplary communication system incorporating an antenna control circuit in accordance with embodiments of the present disclosure;

FIG. 3 depicts a coordinate system in relation to an aircraft in accordance with embodiments of the present disclosure;

FIG. 4 depicts a coordinate system in accordance with embodiments of the present disclosure;

FIG. 5 depicts an aircraft steering an antenna toward a truth source in accordance with embodiments of the present disclosure;

FIG. 6 depicts components of a control circuit in accordance with embodiments of the present disclosure; and

FIG. 7 is a flowchart illustrating aspects of a method in accordance with embodiments of the present disclosure.

### DETAILED DESCRIPTION

Communication systems enable connectivity between vehicles, such as an aircraft, and external networks, including ground-based stations, and other vehicles. Communication systems allow for the transmission of critical information, including navigation data, weather updates, and passenger communications. Communication systems, in particular, play a vital role in ensuring reliable connectivity for aircraft over areas where ground-based infrastructure is limited or unavailable, such as over oceans or remote regions.

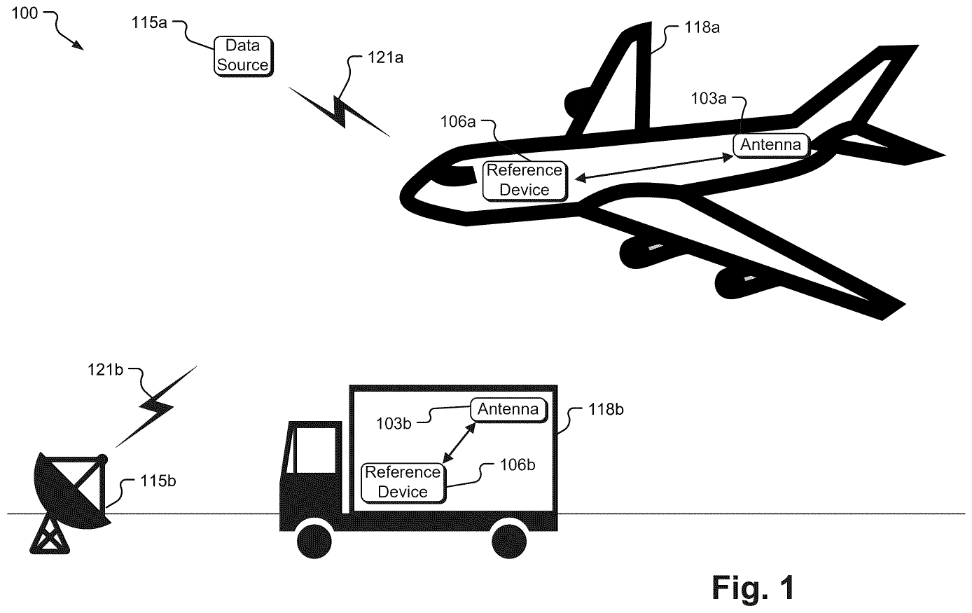

As illustrated in FIG. 1, vehicles 118a, 118b such as trucks, cars, airplanes, trains, ships, rockets, and/or any other type of moving vehicles, may be equipped with one or more antennas 103a, 103b, which may be used to establish communication between the vehicle 118a, 118b and communication targets 115a, 115b such as ground stations or any system capable of transmitting data to the vehicle 118a, 118b. An antenna 103a, 103b as described herein may be an electronically steerable array (ESA) or any other type of antenna capable of being steered or orientated toward a communication target 115a, 115b.

To maintain a consistent connection with such communication targets 115a, 115b, a vehicle 118a, 118b may employ one or more directional antennae 103a, 103b. As the vehicle 118a, 118b moves, orientation of directional antennae 103a, 103b, can be adjusted to maintain line-of-sight communication with communication targets 115a, 115b. Various types of directional antennae 103a, 103b, including phased-array antennae and mechanically steered antennae, may be used to enable such communication; however, the effectiveness of such antennae can be impacted by numerous factors, including changes in the aircraft's position, speed, and altitude, as well as atmospheric conditions.

As a vehicle 118a, 118b moves, orientation of an antenna 103a, 103b on the vehicle 118a, 118b must be continually adjusted to account for the change in location and orientation of the vehicle 118 to ensure uninterrupted communication with communication target(s) 115a, 115b. To account for a vehicle's motion and position, a reference device 106a, 106b as described in greater detail below may be used to determine a position and an orientation of the vehicle 118a, 118b. As illustrated in FIG. 1, vehicles 118a, 118b such as trucks, cars, airplanes, trains, ships, rockets, and/or any other type of moving vehicles, may be equipped with a reference device 106a, 106b. Such a reference device 106a, 106b may, for example, include one or more of a Global Navigation Satellite System (GNSS) sensor, a star tracker, a vision-based navigation system, and/or an image recognition system utilized to perform triangulation for determining position and/or one or more of an inertial rate unit, an inertial measurement unit, a gyroscopic sensor, and/or an inertial navigation system for determining an orientation. A reference device 106a, 106b may in some implementations include an orientation determination sensor (i.e., an IRU such as an inertial measurement unit (IMU) and/or an inertial navigation system (INS)).

A GNSS sensor as described herein may refer to any device capable of determining or being used to determine location information using one or more of Global Positioning System (GPS), Galileo, GLONASS, BeiDou, QZAA, IRNSS, and/or Low Earth Orbit satellite networks such as StarLink and LEO.

When an antenna 103a, 103b is installed on a vehicle 118a, 118b, a reference device 106a, 106b may separately be installed on the vehicle 118a, 118b. The antenna 103a, 103b may be installed in a location on the vehicle 118a, 118b different from the location of the reference device 106a, 106b. While the location and orientation information from the reference device 106a, 106b may be used to determine a location and orientation of the vehicle 118a, 118b, the location and orientation of the information from the reference device 106a, 106 must be adjusted to account for differences in position of the antenna 103a, 103b on the vehicle 118a, 118b with respect to the reference device 106a, 106b.

As the vehicle 118a, 118b moves, the location and orientation of the vehicle 118a, 118b may change, requiring a similar change in the orientation of the antenna 103a, 103b. To determine the exact angle to which the antenna 103a, 103b must be steered, the orientation of the antenna 103a, 103b with respect to the reference device 106a, 106b on the vehicle 118a, 118b must first be determined. In some implementations, the orientation of the antenna 103a, 103b with respect to the reference device 106a, 106b on the vehicle 118a, 118b may be determined once as a part of a configuration process when the antenna 103a, 103b is installed on the vehicle 118a, 118b. For example, if the antenna 103a, 103b is not expected to move once installed, the differences between the location and orientation between the antenna 103a, 103b and the reference device 106a, 106b may be constant throughout the life of the vehicle 118a, 118b. However, it should be appreciated that in some implementations, the orientation of the antenna 103a, 103b with respect to the reference device 106a, 106b on the vehicle 118a, 118b may be determined and updated at regular intervals or upon detection that the antenna 103a, 103b is not accurately orientated.

Once the orientation of the antenna 103a, 103b with respect to the reference device 106a, 106b on the vehicle 118a, 118b is known, the antenna 103a, 103b can be steered toward a communication target 115a, 115b based on the location and the orientation of the vehicle 118a, 118b as determined by the reference device 106a.

Controlling the orientation of an antenna requires a technological solution involving complex calculations, precise calibration, and real-time adjustments to track the communication target accurately. Conventionally, an antenna, such as an ESA, includes or is physically attached to a reference device. By including or being attached to the reference device, the orientation of the antenna can be determined based on measurements of the reference device without issue. However, including a reference device with an antenna is costly and can be unnecessary as modern vehicles are typically equipped with reference devices and adding an unnecessary reference device negatively impacts size and weight considerations which are vitally important in vehicle design. Installing an antenna in the same location as an existing reference device is often impractical, impossible, or otherwise not ideal. As a result, what is needed is a control system capable of determining an orientation delta between an antenna and a reference device such that an antenna can be installed anywhere on a vehicle and a reference device located elsewhere on the vehicle can be used to determine an orientation of the antenna. This is a technological problem facing modern control circuits.

Alignment of a steerable antenna 103 to a reference device 106 as described herein is required to be at a high accuracy to guarantee the performance and functionality of the steering of the antenna 103. The systems and methods described herein provide a technological solution involving the use of a state estimation algorithm to orient an antenna 103 such as an ESA relative to a reference device 106 such as a reference device. Systems and methods described herein enable a control circuit to determine an orientation of a receive phased array antenna system 103 relative to a reference device without any physical measurement, by utilizing an arbitrary closed loop track as a truth source to align against. A control circuit as described herein requires relatively little knowledge of its input data and is able to determine alignment angles with high accuracy in a highly variable environment.

The systems and methods described herein utilize radio frequency (RF) signals 121a, 121b received from RF sources, such as data sources 115a, 115b as described below, to determine an orientation of an antenna with respect to a reference device. Such RF sources may be referred to herein as data sources. A data source may be an identifiable source of signals. For example, a control circuit as described herein may be capable of identifying a data source based on received signals and determining a location of the data source, such as by accessing a database storing known position and/or location information for a number of data sources.

While RF is used herein as an example of a range of frequencies of signals which may be used to implement the systems and methods described herein, it should be appreciated that frequences outside the RF range maybe used. An RF source as described herein may be any type of device capable of sending RF signals. To provide an example, but without limiting the systems and methods described herein in any way, an RF signal may be sent via transmitters from network modems. Based on feedback from such a truth source, a control circuit may be enabled to align an antenna toward the data source. The alignment method can work agnostic to the feedback source that is being utilized to provide truth.

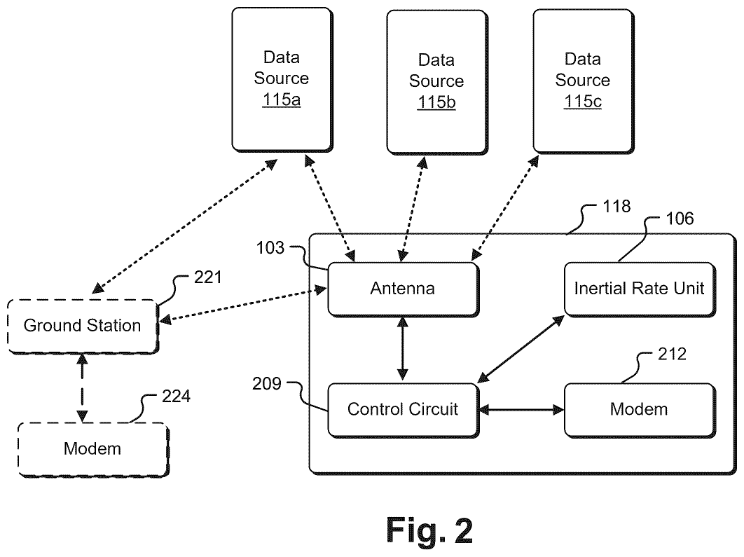

FIG. 2 depicts a vehicle 118 having an antenna 103, a reference device 106, a control circuit 209, and a modem 212, in accordance with embodiments of the present disclosure, in an exemplary operating environment 100. A number of data sources 115a, 115b, 115c may be at a position some distance away from the vehicle 118. Each data source 115a-c may be an RF transmission source with a known frequency and location. In some implementations, the first data source may be an RF emitter with a known frequency and relative position. A known relative position may be in terms of latitude, longitude, and altitude, or an angular local reference such as azimuth and elevation (Az/El) pointing (e.g., unit) vector from a steering origin of the antenna 103. A ground station 221 is illustrated as optionally enabling communication between a ground modem 224 with the modem 212 of the vehicle 118, directly or via one or more of the data sources 115a-c.

As an example, but without limitation, a first data source 115a can be in an equatorial Earth orbit and at an altitude at or about 35,786 km above the equator (i.e., the first data source 115a can be in a geostationary Earth orbit (GEO)), and a second data source 115b can be in an Earth orbit at an altitude of less than 35,000 km above the surface of the Earth (i.e. the second data source 115b can be in a medium Earth orbit (MEO) of between about 2000 km and about 35,000 km or in a low Earth orbit (LEO) of less than 2000 km. As another example, the first data source 115a may be in a first location on the surface of Earth and the second data source 115b may be in a second location on the surface of Earth. These sources can be in combination of any altitude.

An antenna 103 in accordance with embodiments of the present disclosure can be operated to receive, transmit, or transmit and receive signals. As examples, but without limitation, the antenna 103 can be used in connection with the transmission of communication signals between the antenna 103 and other communication nodes, such as a ground station 221 and data sources 115a-c for any purpose.

In some implementations, the vehicle 118 may include an aircraft, such as a commercial airplane, military aircraft, drone, or precision guided munition. The vehicle 118 includes a reference device 106. The reference device 106 may, for example, be located on top of the vehicle 118, on a wing pod of the vehicle 118, or on the tail of the vehicle 118. The reference device 106 may be configured to measure the movement of the vehicle 118. The reference device 106 may include a combination of gyroscopes, accelerometers, and/or other components to capture real-time information about the angular position of the vehicle 118.

The reference device 106 may measure the rate of rotation about each of the principal axes—pitch, roll, and yaw—of the vehicle 118. By continuously sensing the rate of angular movement, the reference device 106 may provide real-time data on the rotational motion of the vehicle 118, allowing the system to maintain an accurate assessment of the orientation of the vehicle 118 relative to a starting reference. Such information may be used for maintaining stable flight and executing precise maneuvers, as well as for steering an antenna 103 of the vehicle as described below.

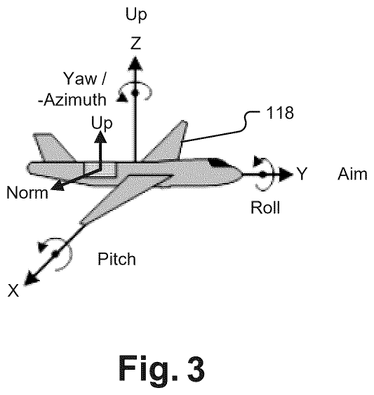

FIG. 3 depicts a vehicle 118 (in this example an aircraft) traveling in a direction along a Y-axis in a three-dimensional (x, y, z) coordinate system (i.e., vehicle coordinates). The Y-axis represents the forward direction of travel, meaning the aircraft is moving along the Y-axis in the coordinate system, which is aligned with the direction the nose of the aircraft is pointing. The X-axis extends horizontally to the left and right of the aircraft, while the Z-axis extends vertically, perpendicular to both the X and Y axes.

Roll may be described as rotation of the aircraft about the forward-traveling Y-axis. When the aircraft rolls, it rotates about its longitudinal axis, causing one wing to move up and the other to move down.

Pitch may be described as rotation of the aircraft about the X-axis, which points horizontally from side to side. When the aircraft pitches, the nose of the aircraft moves up or down relative to the horizon.

Yaw may be described as rotation of the aircraft about the Z-axis, which is the vertical axis extending up and down. When the aircraft yaws, its nose moves left or right in the horizontal plane, which changes its direction without affecting its altitude.

In the coordinate system illustrated in FIG. 3, the up direction corresponds to the positive Z-axis. Up is vertically upward relative to the aircraft and is perpendicular to both the X and Y axes. Up may be used as a reference for defining altitude and/or the aircraft's orientation relative to the horizon. Movements along the Z-axis represent changes in altitude, with positive Z indicating upward movement and negative Z indicating downward movement.

The norm vector, which may be referred to as the normal vector, represents a perpendicular direction relative to the aircraft. In the context of an aircraft in an x, y, z coordinate system as illustrated in FIG. 3, the norm vector may be parallel with the aircraft's wings.

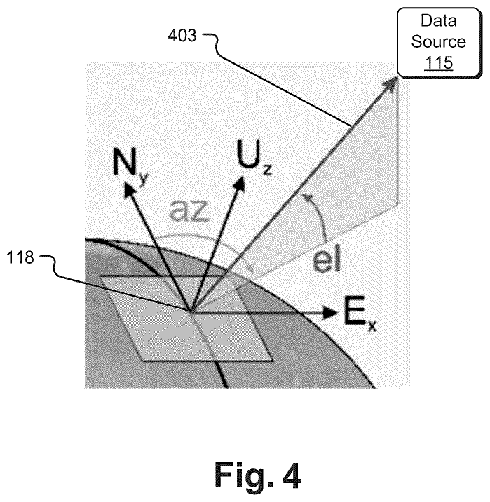

FIG. 4 depicts East, North, Up (ENU) coordinates, which is a version of Local tangent plane coordinates and may be used for local aiming. The Z-axis points upward and is perpendicular to the Earth's surface, with the surface definition established relative to a geodetic model such as WGS-84, at the location of the vehicle 118. The Y-axis points North relative to the local position of the vehicle 118, in the horizontal plane. The X-axis points East in the local horizontal plane, perpendicular to the Y-axis and Z-axis. This is typically referred to as the “ENU” frame (East-North-Up.) The ENU frame is a quasi-inertial frame that is indirectly referred to as the “local” frame.

As illustrated in FIG. 4, Azimuth (Az) may be a horizontal angle, such as may be measured clockwise from a reference direction, such as true north, to the direction of a vehicle's movement or to a specific point of interest. Elevation may be an angle between the horizontal plane, commonly referenced as the local plane parallel to the Earth's surface established with the creation of the ENU coordinate system, and a line of sight from the antenna to a specific point of interest, such as a data source 115. The range 403 of the data source 115 may be a distance from the vehicle 118 to the data source 115.

Referring again to FIG. 2, the modem 212 may be configured to enable transmission and reception of data over various communication networks. In some implementations, the modem 212 may be part of an avionics suite and may be utilized for enabling connectivity to ground stations 221, other aircraft, or data sources 115a-c via the antenna 103. The modem 212 may be configured to support high-speed data transfer via air-to-ground (ATG) networks and/or cellular networks.

The modem 212 may also or alternatively support air-to-ground (ATG) networks to provide high-speed data links when the vehicle 118 is flying over land. For example, the modem 212 may connect to ground-based cellular networks and/or may be used for providing in-flight Wi-Fi services, as well as for operational data transmission, such as real-time engine monitoring and flight status updates.

The antenna 103 may in some implementations be an ESA. The antenna 103 may be designed to enable reliable wireless communication by transmitting and receiving signals with ground stations 221, data sources 115a-c, and/or other vehicles. In the context of an aircraft, a control circuit 209 may be capable of maintaining continuous connectivity via the antenna 103 while the vehicle 118 is in motion, by electronically steering the beam direction of the antenna 103 without requiring physical movement. The antenna 103 may utilize phased-array technology, using a series of small antenna elements that can adjust phase and amplitude to steer the direction of the transmitted and received beams.

The control circuit 209 may be capable of rapidly changing the beam direction of the antenna 103 to track a moving data source 115a-c or a ground station 221, even while the vehicle 118 maneuvers or changes altitude. The control circuit 209 may achieve the electronic beam-steering capability by adjusting the phase shift between individual antenna elements of the antenna 103, enabling precise control over the direction of the signal.

The antenna 103 may be installed on the top, the underside, within, or elsewhere in relation to the vehicle 118, depending on the coverage required. For example, in SATCOM applications, a top-mounted ESA may be used to establish a line-of-sight connection.

While the present disclosure is described in relation to an ESA, it should be appreciated that the antenna 103 could additionally or alternatively be a mechanically steered dish antenna or any other type of device capable of facilitating wireless communication. The type of antenna 103 used may vary based on the communication requirements, frequency band, and installation constraints of the vehicle.

As a vehicle 118, such as an aircraft, moves, the antenna 103 may be continuously directed toward a specific target, such as a data source 115, to maintain a reliable communication link. In some implementations, the control circuit 209 may continuously adjust the beam direction of the antenna 103 to track a location of a data source 115 relative to the vehicle 118. To achieve this, the control circuit 209 may employ scanning and/or sequential lobing techniques to ensure precise alignment with the data source and to optimize signal strength.

Scanning as described herein may refer to the process by which the control circuit 209 steers the antenna 103 to search for and/or lock onto the strongest signal from a data source 115. As the vehicle 118 moves, changes in the orientation and position of the vehicle 118 can affect the line of sight to the data source 115. To maintain the connection, the control circuit 209 may perform small adjustments to the antenna 103 by electronically steering the antenna 103 in various directions around the expected location of the data source. This scanning process allows the antenna to locate and lock onto the strongest point of the data source's signal, which helps ensure stable and high-quality communication.

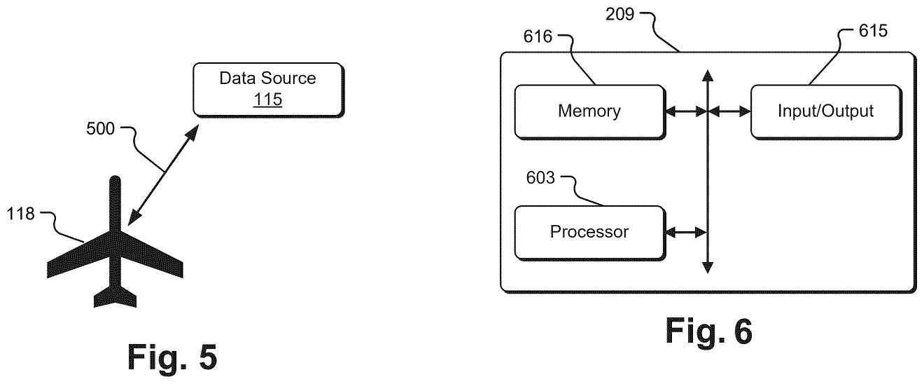

In some implementations, sequential lobing may be used to ensure the antenna 103 remains aligned with a data source 115 by making small, controlled adjustments around the main beam's direction. For example, as illustrated in FIG. 5, a beam 500 of the antenna 103 may be slightly offset in a cross around the target direction of the data source 115. As the control circuit 209 performs sequential lobing using the antenna 103, the control circuit 209 may measure a signal strength at each point along the cross. By comparing the signal strength readings from different points, the control circuit 209 can determine if the current alignment with the data source 115 needs tuning. If the signal strength decreases in one direction, the control circuit 209 can adjust the antenna 103 to compensate, effectively centering the beam on the strongest signal path. In this way, a truth vector may be established. While the systems and methods of the present disclosure are described in relation to using sequential lobing to establish a truth vector, it should be appreciated other methodologies and/or algorithms may be used.

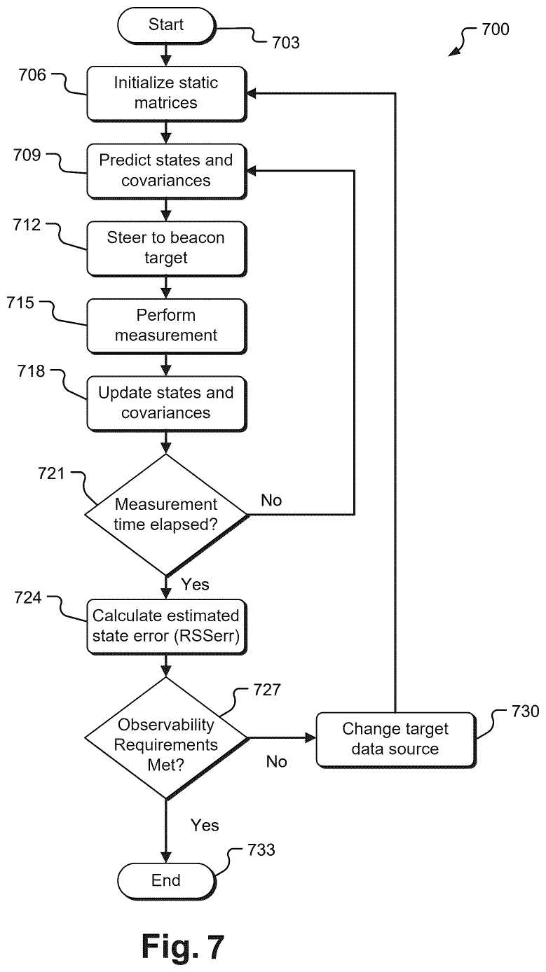

As illustrated in FIG. 6, a control circuit 209 as described herein may include one or more processors 603, memory elements 616, and/or input/output devices 615. The control circuit 209 may be configured to control functionality relating to the antenna 103 of the vehicle 118, such as by orientating the antenna 103 with respect to a reference device 106 and using the orientation of the antenna 103 with respect the reference device 106 to steer the antenna toward one or more data sources 115a-c. The process of orientating the antenna 103 with respect to the reference device 106 may be as described below in relation to FIG. 7.

The control circuit 109 may incorporate one or more processors 503 which may include general-purpose processors (e.g., CPUs) or specialized processors (e.g., microcontrollers or digital signal processors (DSPs)) configured to execute specific tasks. The processors 603 may execute instructions and perform functions necessary for controlling the antenna 103.

The control circuit 109 may further include memory elements 606 such as random-access memory (RAM), read-only memory (ROM), and non-volatile storage like flash memory. RAM may be used to store temporary data and instructions actively used by the processors 603, while ROM or other non-volatile memory may hold firmware or critical system data.

The control circuit 209 may also include I/O devices 615 which may facilitate interaction with other components or user interfaces. Such I/O devices 615 may include interfaces for sensors, actuators, display units, keyboards, and other peripherals that allow for data input and output.

FIG. 7 is a flowchart illustrating aspects of a method 700 for orientating an antenna 103 with respect to a reference device such as a reference device 106 in accordance with embodiments of the present disclosure. The method 700 may be implemented by one or more processors 603 of a control circuit 209 that execute instructions. Such instructions may be stored in memory elements 606 of the control circuit 209.

The control circuit 209 may, as a part of the method 700, use a state estimation algorithm to derive alignment error between a reference device 106 and an antenna 103. A state estimation algorithm as described herein may in some implementations be a UKF, an Extended Kalman filter (EKF), a state observer (such as a Luenberger observer, Sliding Mode observer, or ‘Machine Learning/Trained’ model), or any other algorithm capable of providing estimates of unknown variables (states) given measurements of some known variables observed over time.

The states estimated by the state estimation algorithm may be differences in angles in three-dimensions, such as yaw, pitch, and roll, between the reference device 106 and the antenna 103. These states may collectively be referred to as a state of alignment angles. For example, the states (x) estimated by the state estimation algorithm may be represented by a 3×1 vector,

$$\hat{x} = [ \begin{matrix}yaw \\ Δ pitch \\ Δ roll\end{matrix} ] ,$$

where Δyaw is a change in yaw, Δpitch is a change in pitch, and Δroll is a change in roll. While yaw, pitch, and roll are used here as examples, it should be appreciated that any angles about three-orthogonal dimensions may be used. Such angles, which may or may not be yaw, pitch, and roll, may be referred to as misalignment angles.

The method 700 also involves the control circuit 209 implementing a truth determining track algorithm which monitors and adjusts the orientation of the antenna 103 to align with a data source 115. The truth determining track algorithm may be configured to output azimuth and elevation (AzEl) angles, where the azimuth is a horizontal angle, and the elevation is a vertical angle based on the position of the data source 115 relative to the antenna 103. The output of the closed loop algorithm may be represented by a 2×1 vector,

$$z = [ \begin{matrix}{Az}_{c l} \\ {El}_{cl}\end{matrix} ] ,$$

where Az_{cl} is the azimuth angle and El_{cl} is the elevation angle.

The state estimation algorithm implemented by the control circuit 209 may utilize the AzEl output of the truth determining track algorithm as the measurements to determine the misalignment angles. The misalignment angles, which may be referred to as states, may be used to correct installation offsets for the antenna 103 being used to measure the AzEl outputs.

The method 700 may start 703 with an antenna 103 of a vehicle 118 which is misaligned with a reference device 106 of the vehicle 118. An initial target data source, such as a data source 115, may be selected using a beacon database and a selection algorithm to determine the target.

A beacon database as described herein may be a data file stored within or in communication with a control circuit 209 such as illustrated in FIG. 6. The beacon database may store known position and location information relating to data sources 115 as described herein. For example, a beacon database may contain data identifying data sources 115 and associating each data source 115 with data such as geographic coordinates (e.g., latitude, longitude, and altitude) and in the case of moving data sources 115, timestamps, velocity, and heading. The information in the database can be dynamically updated in real-time as data sources 115 move, such that the data reflects a current location of each data source 115.

The data in the beacon database may be organized in structured formats, with tables defining fields for position (latitude, longitude, altitude), time (timestamp), and other optional attributes like movement. In some implementations, the beacon database may continuously update entries as data sources 115 move.

The initial target data source, such as a data source 115, may be selected using a selection algorithm to determine the target. The initial target data source may in some implementations be selected based on a location of the vehicle 118 relative to locations of data sources 115 listed in the beacon database. For example, the selection algorithm may perform a distance calculation and compute a distance between the vehicle 118 and one or more data sources 115. An initial target data source may be selected based on the distance calculation. As should be appreciated, other mechanisms may be used to select the initial target data source in some implementations.

At 706, the static matrices of the misalignment angles, and roll may be set to an initial value. In some implementations, the delta yaw, pitch, and roll may each be set to zero, as initial estimates of antenna alignment error in the yaw, pitch, and roll directions, respectively.

At 709, a prediction of the states (i.e., misalignment angles) and state error covariances may be calculated. In the initial pass through the method 700, the prediction of the states and state error covariances may be equal to the initialized values. If and when the prediction at 709 is repeated as described below, the prediction of the states and covariances may be based on updated states and covariances as described below in relation to updating the states and covariances at 718.

Next, at 712, the control circuit 209 may steer the antenna 103 toward the selected target data source using the predicted states and covariances. In some implementations, the antenna may be steered toward the target data source using open loop steering. For example, the control circuit 209 may utilize the ground station database and determine a position of the target data source relative to the reference device 106 of the vehicle 118. Next, the control circuit 209 may estimate a position of the target data source relative to the antenna 103 using the states and covariances predicted at 709. Using the positional data, the control circuit 209 may estimate an azimuth and elevation to point the antenna 103 to the target data source. Using the estimated azimuth and elevation, the control circuit 209 may steer the antenna 103 toward the estimated position of the target data source relative to the antenna 103.

After steering the antenna 103, the control circuit 209 may perform a measurement by attempting to use the antenna 103 to collect data from the target data source. In some implementations, the received data may be a received signal strength indicator (RSSI). The RSSI may be a measurement of a power level of a signal received by the target data source or in some implementations, the control circuit 209 may use received data to determine an RSSI by measuring the power level of a signal received from the target data source.

In other implementations, the data may be other types of data. It should be appreciated that the method 700 may be performed using any type of data, or energy, which may be broadcast from an RF data source. As an example, the data received from the target data source may be a continuous wave signal broadcast from the target data source. In such implementations, the control circuit 209 may be configured to perform digital signal processing of the continuous wave signal to determine a signal quality or strength.

At 718, the measurements performed at 715 may be used to update the predicted states and error covariances to improve the predicted alignment error between the antenna 103 and the reference device 106. Updating the predicted states and error covariances may include calculating a predicted measurement (i.e., what the steer angles would be for the current target data source using the current estimate of the alignment errors), calculating a measurement residual (the difference between the actual observed measurement performed at 715 and the predicted measurement), updating a gain of the state estimation algorithm, and updating the predicted states and error covariances by feeding the gain of the state estimation algorithm and the measurement residual into the prediction.

The control circuit 209 may be configured to repeat the steps of predicting the states and covariances at 709, steering to the target data source at 712, performing the measurement at 715, and updating the states and covariances at 718 for a preconfigured amount of time (e.g., 300 seconds). After updating the states and covariances, the control circuit 209 may determine how much time has elapsed since initializing the static matrices at 706 and, at 721, determine whether a measurement time has elapsed.

If the measurement time has not elapsed at 721, then the control circuit 209 may use the updated states and covariances as the new predicted states and covariances at 709, and at 712, re-orientate the antenna 103 toward the target data source based on the updated states. This process may continue over the preconfigured amount of time, fine-tuning the states and covariances.

After the measurement time has elapsed, at 724, the control circuit 209 may calculate an estimated state error. In some implementations, the estimated state error may be calculated by first calculating a UKF error:

$$UKFerr = [ \begin{matrix}\sqrt{KalmanEr {rorCovPost}_{00}} * \frac{180}{pi} \\ \sqrt{{KalmanErrorCovPost}_{11}} * \frac{180}{pi} \\ \sqrt{{KalmanErrorCovPost}_{22}} * \frac{180}{pi}\end{matrix} ] ,$$

where KalmanErrorCovPost₀₀ represents the previous state error covariance output for the yaw state, KalmanErrorCovPost₁₁ represents the previous state error covariance output for the pitch state, and KalmanErrorCovPost₂₂ represents the previous state error covariance output for the roll state. While UKF is used here as an example, it should be appreciated the systems and methods described herein are not limited to using UKF but may instead use another state estimation algorithm. Next, a root sum squared error (RSSerr) may be calculated as follows:

$$RSSerr = \sqrt{{( {UKFerr}_{0} )}^{2} + {( {UKFerr}_{1} )}^{2} + {( {UKFerr}_{2} )}^{2}} .$$

In some implementations, a vector (defined in either spherical (az,el) (theta,phi) or cartesian (X, Y, Z)) may be used as a truth source. The method of using a vector as a truth source allows for not having to fully characterize a truth source before attempting to estimate states to align the system. The vector may indicate an angle and/or a position of a data source with a known location relative to the antenna or relative to a reference device.

After calculating the RSSerr, the control circuit 209 may determine whether one or more observability requirements have been met at 727. Such observability requirements may in some implementations include comparing the RSSerr to a threshold at 727. The threshold may be a configurable value (e.g., 1.5 degrees). If the RSSerr is less than the threshold, and/or if other observability requirements have been met, the method 700 may end at 733 with the antenna 103 being considered oriented according to the alignment differences between the antenna 103 and the reference device 106. Once the observability requirements have been met, the updated states may be used to steer the antenna 103 to provide a communication service for the vehicle 118. If, on the other hand, the observability methods have not been met, the method 700 may continue with selecting a new target data source at 730 and repeating with newly initialized static matrices at 706. The method 700 may continue repeating as necessary until the observability requirements have been met. In some implementations, upon the observability requirements being met at 727, a confirmation indication may be generated and transmitted to a communication target to commence communication.

In some implementations, the control circuit 209 may require changing the target data source at 730 a particular number of times. If the target data source has been changed a predetermined number of times and the observability requirements have not been met, the control circuit 209 may cause the vehicle 118 to perform maneuvers or to otherwise adjust a position of the antenna to achieve a sufficient angular separation with a target data source.

The measurements taken with respect to the data sources enable a positional relationship between a reference device 106, such as an IRU, and an antenna 103, such as an ESA. In this way, an erroneous understanding of the positional relationship between the reference device 106 and the antenna 103 may be resolved. Once the correct positional relationship via a method such as described above is determined, accurate pointing can be performed without requiring repeated measurements from data sources. That is, once the antenna 103 is calibrated, the antenna 103 can be pointed accurately using data from the reference device 106.

While the above description refers to an ESA, it should be appreciated that the same or similar methods may be used to align multiple beams and/or arrays to a single measurement source. For example, arrays may be developed that are a combination of many small arrays that combine their beams at a later point. Conventionally, lasers and laser reflectors are required to align such arrays. The requirement for lasers and laser reflectors for such alignment would be unnecessary using the methods and systems described herein. Further, the systems and methods described herein may be used to align dish antennae as well as ESAs and/or other types of antennae.

In some implementations, the systems and methods described herein may include performing a state estimation algorithm in whole or in part by a machine-learning (ML) model, such as one executed by one or more processors 603 of a control circuit 209 as described above. Such a ML model may for example be configured to generate estimates of misalignment angles (e.g., Δyaw, Δpitch, Δroll) between an antenna 103 and a reference device 106, provide a confidence or uncertainty measure for such estimates, and/or select and/or implement steering actions based on the estimates and/or the confidence or uncertainty measure.

In at least one implementation, a neural network or other model may receive, as inputs, features derived from one or more of: measurement data, reference device signals, vehicle motion and/or location information, and data from a database (e.g., known Az/El or unit vectors associated with one or more truth sources). The model may be configured to output a vector of misalignment angles and, in some cases, a corresponding uncertainty vector. A control circuit may be used to interpret and act in response to the model's output.

As should be appreciated, any function, operation, or algorithm described herein (including estimating states, selecting steering actions, filtering, decision logic, control, and diagnostics) may be performed by, assisted by, or implemented in whole or in part using a machine-learning model or artificial intelligence (AI) system. Execution of such models or systems may occur on general-purpose processors, DSPs, GPUs, DPUs, FPGAs, dedicated accelerators, or distributed/cloud resources. References herein to circuits, processors, modules, controllers, filters, estimators, and algorithms may encompass implementations realized via AI/ML, deterministic logic, or a combination thereof. It is to be appreciated that any feature described herein can be claimed in combination with any other feature(s) as described herein, regardless of whether the features come from the same described embodiment.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A control circuit for orientating an antenna with respect to a reference device, the control circuit configured to:
estimate a state of alignment angles of the antenna as compared to the reference device;
steer the antenna toward a first data source based on the estimated state of alignment angles;
perform a measurement of data received from the first data source;
based on the measurement of the data from the first data source, determine an error in the estimated state of alignment angles;
update the estimated state of alignment angles based on the determined error; and
orientate the antenna with respect to the reference device based on the updated estimated state of alignment angles.

2. The control circuit of claim 1, further configured to:
use the updated estimated state of alignment angles to steer the antenna toward a second data source;
perform a measurement of data received from the second data source; and
based on the measurement of the data received from the second data source, update the updated estimated state of alignment angles.

3. The control circuit of claim 1, further configured to repeat estimating the state of alignment angles, steering the antenna, determining the error, updating the estimated state of alignment angles, and orientating the antenna based on the updated estimated state of alignment angles for a preconfigured amount of time.

4. The control circuit of claim 1, wherein determining the error in the estimated state of alignment angles comprises calculating a measurement residual based on the data.

5. The control circuit of claim 1, wherein the error in the estimated state of alignment angles is determined using a state estimation algorithm.

6. The control circuit of claim 1, wherein the antenna is steered toward the first data source using open loop steering.

7. The control circuit of claim 1, wherein the data is one of a received signal strength indicator (RSSI), a signal-to-noise ratio (SNR), a signal-to-interference-plus-noise ratio (SINR), an energy per symbol to noise power spectral density ratio (E_{S}/N₀), or an energy per bit to noise power spectral density ratio (E_{b}/N₀).

8. The control circuit of claim 1, further configured to determine the error in the estimated state of alignment angles is less than a threshold.

9. The control circuit of claim 1, further configured to determine the error in the estimated state of alignment angles is greater than a threshold.

10. The control circuit of claim 9, further configured to, in response to determining the error in the estimated state of alignment angles is greater than the threshold, use the updated estimated state of alignment angles to steer the antenna to a second data source and repeat estimating the state of alignment angles, steering the antenna, determining the error in the estimated state of alignment angles, updating the estimated state of alignment angles, and orientating the antenna based on the updated estimated state of alignment angles for a preconfigured amount of time.

11. The control circuit of claim 1, wherein the reference device comprises one or more of an inertial rate unit, an inertial measurement unit, a gyroscopic sensor, an inertial navigation system, a vision-based navigation system, and a star tracker.

12. The control circuit of claim 1, wherein the antenna comprises one of an electronically steered array (ESA), a phased array, a parabolic antenna, or a dish antenna.

13. The control circuit of claim 1, wherein the data comprises a continuous wave signal broadcast from an RF source, and wherein the control circuit is further configured to perform digital signal processing of the continuous wave signal to determine the error in the estimated state of alignment angles.

14. The control circuit of claim 1, wherein the estimated state of alignment angles comprises misalignment angles.

15. The control circuit of claim 1, wherein determining the error in the estimated state of alignment angles comprises measuring a vector relative to the antenna.

16. A computer program product including one or more non-transitory machine-readable mediums encoded with instructions that when executed by one or more processors cause a process to be carried out for orienting an antenna, the process comprising:
estimating a state of alignment angles of the antenna as compared to the reference device;
steering the antenna toward a first data source based on the estimated state of alignment angles;
performing a measurement of data received from the first data source;
based on the measurement of the data from the first data source, determining an error in the estimated state of alignment angles;
updating the estimated state of alignment angles based on the determined error; and
orientating the antenna with respect to the reference device based on the updated estimated state of alignment angles.

17. The computer program product of claim 16, wherein the process further comprises repeating estimating the state of alignment angles, steering the antenna, determining the error, updating the estimated state of alignment angles, and orientating the antenna based on the updated estimated state of alignment angles for a preconfigured amount of time.

18. The computer program product of claim 16, wherein determining the error in the estimated state of alignment angles comprises calculating a measurement residual based on the data.

19. A method for orientating an antenna with respect to a reference device, the method comprising:
estimating a state of alignment angles of the antenna as compared to the reference device;
steering the antenna toward a first data source based on the estimated state of alignment angles;
performing a measurement of data received from the first data source;
based on the measurement of the data from the first data source, determining an error in the estimated state of alignment angles;
updating the estimated state of alignment angles based on the determined error; and
orientating the antenna with respect to the reference device based on the updated estimated state of alignment angles.

20. The method of claim 19, further comprising repeating estimating the state of alignment angles, steering the antenna, determining the error, updating the estimated state of alignment angles, and orientating the antenna based on the updated estimated state of alignment angles for a preconfigured amount of time.
